(19) United States
(12) Patent Application Publication
(10) Pub. No.: US 2016/0258366 A1
(43) Pub. Date: Sep. 8, 2016

(54) METHOD FOR CHECKING THE FUNCTION OF AN OUTLET VALVE LIFT ADJUSTMENT

(71) Applicant: Robert Bosch GmbH, Stuttgart (DE)

(72) Inventors: Stefan Gottlieb, Hemmingen (DE); Stefan Kluever, Oeffingen (DE)

(21) Appl. No.: 15/052,734

(22) Filed: Feb. 24, 2016

(30) Foreign Application Priority Data
Mar. 3, 2015 (DE) 102015203770.3

(51) Int. Cl. F02D 13/02; F01L 1/26

(52) U.S. Cl. CPC F02D 13/0246; F01L 1/267; F01L 2800/11

(57) ABSTRACT

A method and a system are provided for checking the function of an outlet valve lift adjustment system. It is thereby ascertained on the basis of a combustion rate whether a switchover has taken place.

### CROSS REFERENCE

The present invention claims the benefit under 35 U.S.C. §119 of German Patent Application No. 102015203770.3 filed on Mar. 3, 2015, which is expressly incorporated herein by reference in its entirety.

### FIELD

The present invention relates to a method for checking the function of an outlet valve lift adjustment system and a system for carrying out the method.

### BACKGROUND INFORMATION

Internal combustion engines, which convert thermal energy from a combustion into kinetic energy, for example, to drive a vehicle, generally include multiple cylinders with a respective number of combustion chambers which are opened or closed by valves in order to enable a gas exchange necessary for a combustion process. For this purpose, inlet and outlet valves are used which are also referred to as gas exchange valves.

The inlet and outlet valves are usually actuated via a camshaft. The camshaft and, if applicable, other equipment for actuating the gas exchange valves are referred to herein as the valve lift adjustment. In an internal combustion engine with variable valve trains, the gas exchange valves may follow different lift curves. In particular, a system including an outlet valve lift adjustment may switch between multiple curve shapes, so-called profiles.

Outlet valve lift adjustments are used in gasoline engines, in particular for four- and eight-cylinder engines, but also in engines with five and ten cylinders, in order to achieve an increased torque in the low speed range due to reduced outlet overlapping at shortened valve lift curves, without having to accept power losses in the high speed range due to an excessively low maximum charge.

Above all, hydraulically actuated systems, in which a switch between the cam profiles is carried out by oil-pressure activated engagement of a connecting pin between two rocker arms, do not offer any direct feedback, which provides information as to whether the switch has already been carried out, without additional sensors.

### SUMMARY

In accordance with an example embodiment of a method according to the present invention, it is checked whether a switchover, i.e., a change of the cam profile of the outlet valve, which is effectuated by a switchover activation, has actually taken place.

The presented method enables, in particular, the ascertainment of the present state of, for example, the position, of the outlet valve lift adjustment system, for example, on the basis of the rotational speed signal. It should be considered hereby that individual cylinders which are not switched may also be identified. Furthermore, the described example method enables a diagnosis of the outlet valve lift adjustment system via the position estimation of the outlet valve lift curves (“active” cam profile). In this way, a position feedback sensor, which would otherwise be necessary, may be omitted.

The active cam profile is the presently effective valve lift curve (profile) of the valve lift system. Valve adjustment system is the generic term for valve lift adjustment systems, in particular those for the adjustment of the outlet valve lift.

Additional advantages and embodiments of the present invention result from the description and the figures.

It is understood that the previously named and the subsequently to be explained features may be used, not only in the respectively indicated combination, but also in other combinations or alone without departing from the scope of the present invention.

### BRIEF DESCRIPTION OF THE DRAWINGS

FIG. 1 shows a schematic representation of a cylinder of an internal combustion engine,

FIG. 2 shows a flow chart of a possible execution of the example method.

### DETAILED DESCRIPTION OF EXAMPLE EMBODIMENTS

The present invention is schematically illustrated in the figures on the basis of specific embodiments, and will subsequently be described in greater detail below with reference to the figures.

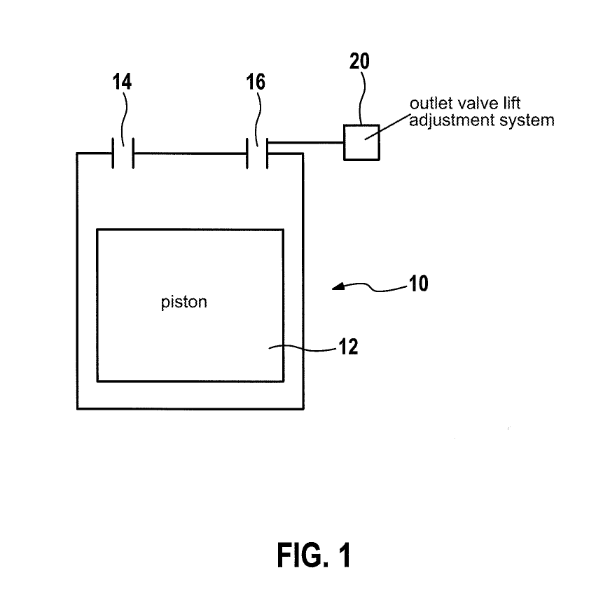

FIG. 1 shows a schematic representation of a cylinder, which is collectively designated with reference numeral 10. A piston 12 is guided in cylinder 10. For gas exchanges, gas exchange valves are provided, namely an inlet valve 14 and an outlet valve 16. An outlet valve lift adjustment system 20 is assigned to outlet valve 16. This system 20 is coupled to the camshaft.

It should be noted that, in engines without combustion chamber pressure sensors, e.g., a function which is referred to as a mechanical work feature, the estimation of the position of the center and the average pressure of a combustion is enabled based on the evaluation of the rotational speed signal.

In accordance with the example method, the combustion energy is converted into a piston acceleration, and thus into an acceleration of the crankshaft drive and the engine speed sensor wheel connected thereto. At a later position of the center of combustion, the energy input into the crankshaft drive takes place later, and thus the acceleration of the sensor wheel occurs at a later point in time. The position of the center of the combustion may be estimated from the point in time at which the acceleration takes place. The ignition point is an additional variable which is predefined by the engine controller, and which is consequently available for additional processing.

The position of the center defines the center of the combustion in the heating curve. The center defines that point at which half of the amount of fuel injected is combusted.

The ignition point refers to the point in time at which the ignition takes place. This is generally predefined by the engine controller and is available for further use.

The mechanical work feature function is described in German Patent Application No. DE 10 2008 054 690 A1, which relates to a method for calibrating the injection quantity of at least one partial injection of an internal combustion engine provided in addition to a main injection. The mechanical work feature function provides that a rotational speed signal is scanned with high frequency and, on the basis thereof, accelerations of the engine speed sensor wheel, and thus speed changes of the internal combustion engine, may be detected with high accuracy. On the basis of this evaluation, variables which characterize the combustion are ascertained. The position of the center of the combustion may be thus determined, among other things.

The residual gas content in the combustion chamber changes due to the switchover to a narrower or broader outlet cam profile with lower or greater overlapping between the cylinders. Due to the increased residual gas content, the combustion rate in the cylinder is reduced. Thus, the position of the center of the combustion is shifted toward retarded, which is usually compensated for by an advanced ignition point.

In the example embodiment, the presented method uses the position of the center derived from the rotational speed evaluation via the mechanical work feature function. The combustion rate is estimated from the difference between the position of the center and the ignition point. If the charge moving flap is adjusted, then an estimation value of the combustion rate, which is stored prior to the adjustment process, is compared to the value after the adjustment. A correct change of the cam profile may be detected by comparing the combustion rate prior to and after a switchover activation. The expected difference may be stored, e.g., in an operating point-dependent characteristic map. This may be carried out, if applicable, to correct for additional influences, such as for example temperature, elevation, combustion process.

If the information is generated for individual cylinders, an error function of individual cam pieces or rocker arms, e.g. due to a jammed connecting pin or a sheared-off actuation pin, may also be detected by the method, insofar as the evaluation is individually available for each cylinder.

For engines including combustion chamber pressure sensors, the position of the center of the combustion or the position of the center may also be inferred from the cylinder pressure curve.

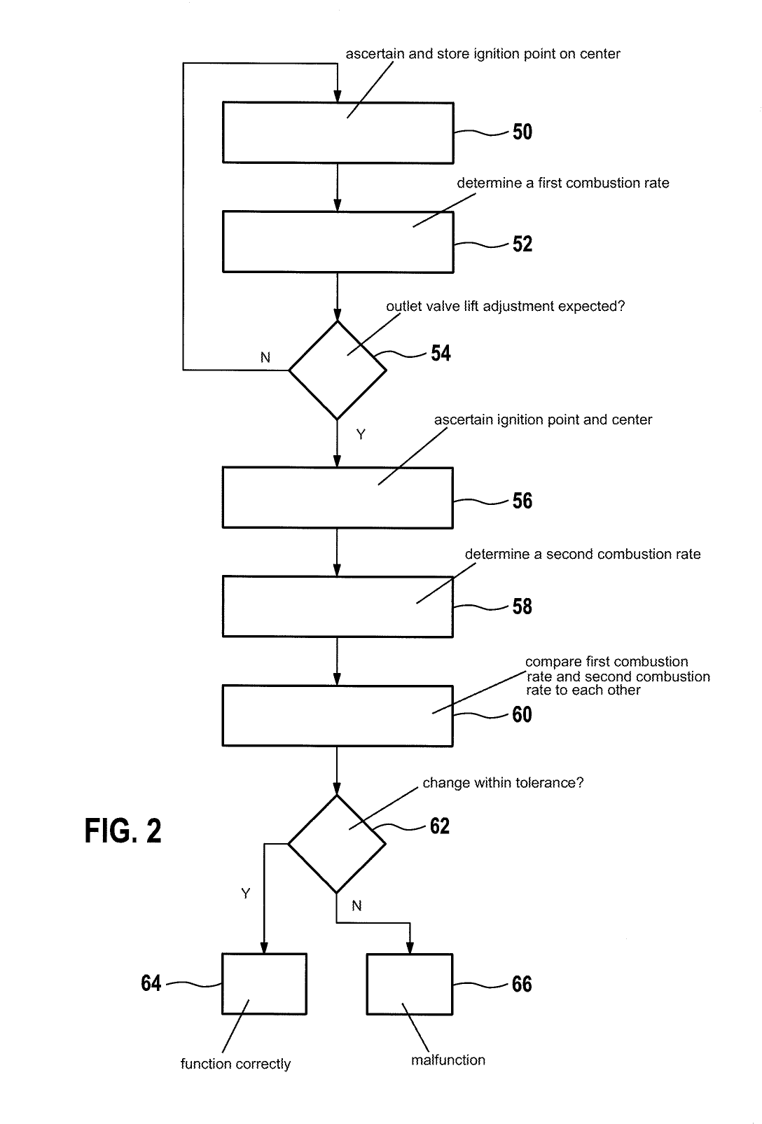

FIG. 2 shows a possible sequence of the presented method. According to this, ignition point Z and the position of center S of the associated combustion are ascertained and stored in a first step 50. A first combustion rate B is inferred from the resulting difference in a step 52:

B=S−Z (1)

If an outlet valve lift adjustment is expected, i.e., a trigger at the switchover system which takes dead time into account (step 54), then ignition point Z′ and the associated position of center S′ are ascertained again (step 56). Otherwise, the method returns to step 50. Subsequent to step 56, the difference

B′=S′−Z′ (2)

and thus a second combustion rate B′ is ascertained in a step 58. The change of the combustion rate prior to and after the expected switchover is compared in a step 60 to an expected value, e.g., from an operating point-dependent characteristic map or from a combustion model. If the change lies within an applicable tolerance (step 62), then a correct switchover is assumed. The system functions correctly (step 64). Otherwise, a malfunction is assumed (step 66). Steps 56 through 62 may be repeated multiple times in order to detect a delayed switchover, in particular in the case of a hydraulic system, or to guarantee a more reliable detection.

The example method may be used, in particular, in engine controllers for internal combustion engines with the potential for adjusting the outlet valve, in particular, in hydraulic adjustment systems without direct position feedback.

What is claimed is:

1. A method for checking a function of an outlet valve lift adjustment system in an internal combustion engine of a motor vehicle, comprising:
comparing a first combustion rate prior to a switchover activation and a second combustion rate after the switchover activation with each other to determine, on the basis of the comparison, whether a switchover has taken place.

2. The method as recited in claim 1, wherein the first combustion rate is ascertained from a position of a center and an ignition point with using the difference thereof.

3. The method as recited in claim 2, wherein the position of the center is determined using a rotational speed evaluation.

4. The method as recited in claim 2, wherein the position of the center is inferred from a cylinder pressure curve.

5. The method as recited in claim 2, wherein the ascertained difference is compared with an expected difference stored in a characteristic map.

6. The method as recited in claim 5, wherein additional influences are taken into account in the characteristic map.

7. The method as recited in claim 2, wherein the ascertained difference is compared with an expected difference from a combustion model.

8. The method as recited in claim 1, wherein an individual cylinder evaluation is carried out.

9. A system for checking a function of an outlet valve lift adjustment system in an internal combustion engine of a motor vehicle, the system being configured to compare a first combustion rate prior to a switchover activation and a second combustion rate after the switchover activation with each other to determine, based on the comparison, whether a switchover has taken place.
